(19) United States
(12) Patent Application Publication
(10) Pub. No.: US 2023/0347919 A1
(43) Pub. Date: Nov. 2, 2023

(54) HAND FRICTION ESTIMATION FOR ESTIMATING GUARDIAN USER OR CHAUFFEUR SAFETY DRIVER PREFERENCE

(71) Applicant: TOYOTA RESEARCH INSTITUTE, INC., Los Altos, CA (US)

(72) Inventors: MANUEL AHUMADA, Los Altos, CA (US); Sarah M. Koehler, Los Altos, CA (US); Matthew J. Brown, Los Altos, CA (US)

(73) Assignees: TOYOTA RESEARCH INSTITUTE, INC., Los Altos, CA (US); TOYOTA JIDOSHA KABUSHIKI KAISHA, Toyota-Shi (JP)

(21) Appl. No.: 17/732,092

(22) Filed: Apr. 28, 2022

(51) Int. Cl. B60W 50/10; B60W 60/00

(52) U.S. Cl. CPC B60W 50/10; B60W 60/001; B60W 2540/18; B60W 2710/202; B60W 2710/205; B60W 2710/207

(57) ABSTRACT

The disclosure generally describes a system and method for determining a preferred steering wheel rate in autonomous and semi-autonomous driving systems that includes measuring a torque applied to the steering wheel by a driver during an autonomous driving mode, measuring the steering wheel position, measuring the steering wheel rate of rotation, wherein the steering position and rate of rotation are measured at the time when the torque was applied to the steering wheel, determining a preferred steering wheel rate of rotation, and adjusting the steering wheel rate of rotation during an autonomous driving maneuver to include the preferred steering wheel rate.

### TECHNICAL FIELD

The present disclosure relates generally to a system and method for monitoring driving task-related behavior. In particular, some implementations include a system that adjusts the steering wheel rate of rotation based on observed driver preferences when the vehicle is in a guardian or chauffeur mode.

### DESCRIPTION OF RELATED ART

Most autonomous or semi-autonomous driving systems physically actuate the steering wheel when the vehicle engages in a driving maneuver. Thus, when the vehicle turns to the left or right, the steering wheel rotates appropriately. However, in some situations, the driver may prefer that the vehicle engage in a driving maneuver faster or slower than the autonomous or semi-autonomous system is programmed to engage. For example, an autonomous vehicle may engage in a right hand turn at a first speed that the driver may feel is too fast. A common driver reaction is to grab the steering wheel and attempt to decelerate the rotation of the steering wheel to decelerate the rate of the turn. However, when this occurs, the steering of the vehicle by an autonomous driving module effectuating motive control of the vehicle may be impacted. Moreover, torque provided by the hand of the driver to attempt to slow down the steering performed by the autonomous driving module may provide additional steering torque which can result in an unstable steering situation.

### BRIEF SUMMARY OF THE DISCLOSURE

According to various embodiments, the disclosed technology includes a method for adjusting a rate of rotation of a steering wheel in an autonomous vehicle that includes measuring a torque applied to the steering wheel at a first time period by a driver during an autonomous driving mode, measuring a position of the steering wheel at the first time period, measuring the rate of rotation at the first time period, determining a preferred rate of rotation based on the measured position of the steering wheel and rate of rotation at the first time period and adjusting the rate of rotation during an autonomous driving mode, to comport with the preferred rate of rotation.

In one embodiment, the method of adjusting a rate of rotation of a steering wheel in an autonomous vehicle includes measuring a torque applied to the steering wheel by a driver during an autonomous driving mode, wherein the torque is applied to the steering wheel by the driver to interrupt an autonomous driving maneuver, measuring the steering wheel position at a time of interruption, measuring the steering wheel rate of rotation at the time of interruption, determining a preferred rate of rotation based on the measured steering wheel position and rate of rotation at the time of interruption, and adjusting the rate of rotation, during an autonomous driving mode, to include the preferred steering wheel rate of rotation.

In one embodiment, the disclosed technology includes a system for altering the rate of steering rotation during an autonomous driving mode that includes a processor, and a memory having computer readable instructions stored thereon, which when executed by the processor, cause the processor to: measure a torque applied to the steering wheel by a driver during an autonomous driving maneuver; measure the steering wheel position; measure the rate of rotation, wherein the steering wheel position and rate of rotation are measured at the time when the torque was applied to the steering wheel; determine a preferred steering wheel rate; and adjust the steering wheel rate during an autonomous driving maneuver to include the preferred steering wheel rate.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the systems and methods disclosed herein may be implemented.

FIG. 2 illustrates an example autonomous control system that includes a steering torque adjustment feature, according to one embodiment.

FIG. 3 is a flow diagram of a method of altering an autonomous or semi-autonomous steering wheel rate of rotation, according to one embodiment.

FIG. 4 is a flow diagram of a method of determining a preferred steering wheel rate, according to one embodiment.

FIG. 5 is a flow diagram of an alternative method of determining a preferred steering wheel rate, according to one embodiment.

FIG. 6 is an example computing component that may be used to implement various features of embodiments described in the present disclosure.

The figures are not exhaustive and do not limit the present disclosure to the precise form disclosed.

### DETAILED DESCRIPTION

Most autonomous driving systems include autonomous and semi-autonomous drive modes. One example of an autonomous drive mode is a chauffeur mode. A chauffer mode is a mode where the vehicle requires little to no input from the driver. One example of a semi-autonomous drive mode is a guardian mode. A guardian mode is a mode in which the driver controls the vehicle, but the autonomous driving system can intervene when the vehicle is being piloted in an unsafe manner.

When an autonomous (e.g., chauffer mode) or semi-autonomous (e.g., guardian mode) driving mode controls the vehicle, the steering wheel is actuated (i.e., rotated) according to a driving maneuver. For example, when the vehicle engages in an autonomous driving maneuver, the steering wheel is autonomously controlled to rotate about its center to orientate the vehicle's wheels in accordance with the intended direction of travel. Often times, if the driver determines that he/she wants to slow down or speed up the rate of rotation of the steering wheel, the driver will grab the steering wheel and physically attempt to slow down or speed up the rate of rotation of the steering wheel. The torque provided by the hand of the driver to attempt to slow down or speed up the steering can result in an unstable steering situation. That is, the added torque can impart forces to the steering wheel that translate into undesirable responses from the vehicle. For example, the added torque may not merely speed up/slow down the rate of rotation, but can create oversteer or understeer, resulting in potential fishtailing of the vehicle, or resulting in the vehicle plowing forward despite actuation of the steering wheel. Thus, there is a need for a system that can adjust the rate of rotation of the steering wheel according to the driver's preferred steering wheel rate of rotation during an autonomous or semi-autonomous driving maneuver.

By measuring the amount of torque input or provided by the driver to the steering wheel, and measuring the position and rate of rotation of the steering wheel, the system gathers data regarding the driver's preferred rate of rotation of the steering wheel. This data is stored and used to determine a preferred rate of rotation of the steering wheel in the autonomous or semi-autonomous driving modes. For example, if the driver provided torque to the steering wheel to slow down the steering wheel rate, this information can be captured, and used to determine a preferred rate of rotation. The system can further use stored data for each driver to create a driver profile that can be referenced to adjust the steering wheel rate of rotation to each driver's preferences. Furthermore in one embodiment, the system uses repeated driver interventions during a driving session to determine a preferred rate of rotation without creating a driver profile. For example, after 10 driver interruptions in a driving session, the system determines a preferred steering wheel rate of rotation based on the 10 interruptions, without using a driver profile as a reference.

In one embodiment, the torque applied to the steering wheel by the driver during an autonomous driving maneuver is measured by the steering wheel torque sensor. The measured torque applied to the steering wheel by the driver is sent to the ECU as steering wheel torque data, where it is stored in the memory unit 218. In addition, the steering wheel position and rate of rotation is measured by a position sensor. The measured steering wheel position and rate of rotation is sent to the ECU as steering wheel position and rate data, where it is stored in the memory unit. The calculation unit fetches (i.e., gets) the steering wheel torque data and steering wheel position and rate data from the memory unit and creates preferred steering rate for future autonomous and semi-autonomous driving maneuvers. The preferred steering rate for the steering wheel, is then sent to the control unit and assist unit to alter the rate at which the autonomous and semi-autonomous driving modes engage in an steering maneuver. Furthermore, once the calculation unit determines the preferred steering rate for the steering wheel, the steering rate is stored in memory and associated with the driver to create a driver profile based on that driver's preferred steering wheel rate.

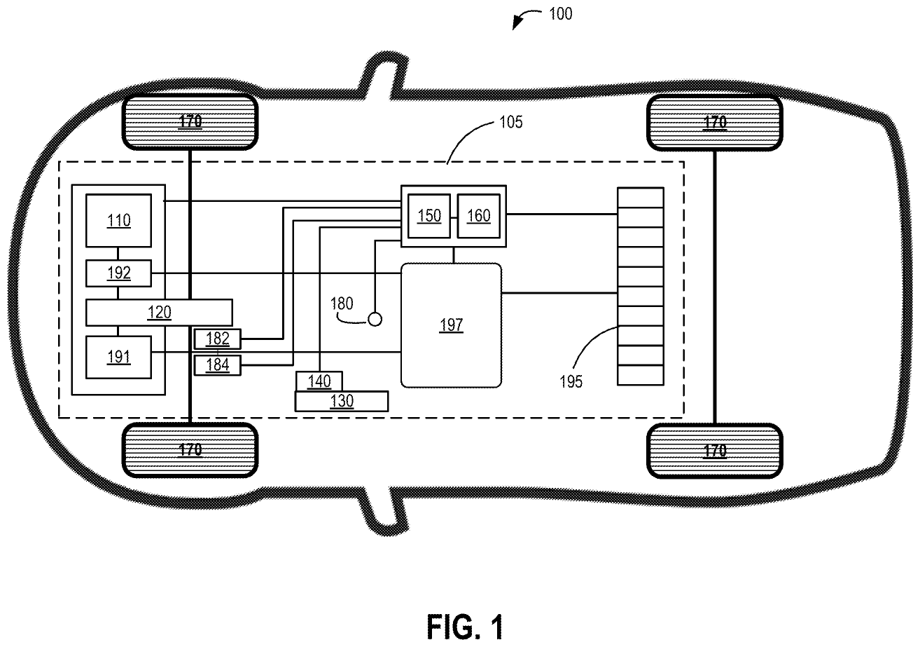

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example of a hybrid electric vehicle (HEV) in which embodiments of the disclosed technology may be implemented is illustrated in FIG. 1. Although the example described with reference to FIG. 1 is a hybrid type of vehicle, the systems and methods can be implemented in other types of vehicle including gasoline- or diesel-powered vehicles, fuel-cell vehicles, electric vehicles, or other vehicles.

FIG. 1 illustrates an example hybrid electric vehicle (HEV) 100 in which various embodiments for autonomous and semi-autonomous steering alterations based on a driver profile may be implemented. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 100 includes drive force unit 105 and wheels 170. Drive force unit 105 includes an engine 110, motor generators (MGs) 191 and 192, a battery 195, an inverter 197, a brake pedal 130, a brake pedal sensor 140, a transmission 120, a memory 160, an electronic control unit (ECU) 150, a shifter 180, a speed sensor 182, and an accelerometer 184.

Engine 110 primarily drives the wheels 170. Engine 110 can be an ICE that combusts fuel, such as gasoline, ethanol, diesel, biofuel, or other types of fuels which are suitable for combustion. The torque output by engine 110 is received by the transmission 120. MGs 191 and 192 can also output torque to the transmission 120. Engine 110 and MGs 191 and 192 may be coupled through a planetary gear (not shown in FIG. 1). The transmission 120 delivers an applied torque to the wheels 170. The torque output by engine 110 does not directly translate into the applied torque to the wheels 170.

MGs 191 and 192 can serve as motors which output torque in a drive mode, and can serve as generators to recharge the battery 195 in a regeneration mode. The electric power delivered from or to MGs 191 and 192 passes through inverter 197 to battery 195. Brake pedal sensor 140 can detect pressure applied to brake pedal 130, which may further affect the applied torque to wheels 170. Speed sensor 182 is connected to an output shaft of transmission 120 to detect a speed input which is converted into a vehicle speed by ECU 150. Accelerometer 184 is connected to the body of HEV 100 to detect the actual deceleration of vehicle 210, which corresponds to a deceleration torque.

Transmission 120 is a transmission suitable for an HEV. For example, transmission 120 can be an electronically controlled continuously variable transmission (ECVT), which is coupled to engine 110 as well as to MGs 191 and 192. Transmission 120 can deliver torque output from a combination of engine 110 and MGs 191 and 192. The ECU 150 controls the transmission 120, utilizing data stored in memory 160 to determine the applied torque delivered to the wheels 170. For example, ECU 150 may determine that at a certain vehicle speed, engine 110 should provide a fraction of the applied torque to the wheels while MG 191 provides most of the applied torque. ECU 150 and transmission 120 can control an engine speed (NE) of engine 110 independently of the vehicle speed (V).

ECU 150 may include circuitry to control the above aspects of vehicle operation. ECU 150 may include, for example, a microcomputer that includes a one or more processing units (e.g., microprocessors), memory storage (e.g., RAM, ROM, etc.), and I/O devices. ECU 150 may execute instructions stored in memory to control one or more electrical systems or subsystems in the vehicle. ECU 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 191 and 192 each may be a permanent magnet type synchronous motor including for example, a rotor with a permanent magnet embedded therein. MGs 191 and 192 may each be driven by an inverter controlled by a control signal from ECU 250 so as to convert direct current (DC) power from battery 195 to alternating current (AC) power, and supply the AC power to MGs 191, 192. MG 192 may be driven by electric power generated by motor generator MG 191. It should be understood that in embodiments where MG 191 and MG 192 are DC motors, no inverter is required. The inverter, in conjunction with a converter assembly may also accept power from one or more of MGs 191, 192 (e.g., during engine charging), convert this power from AC back to DC, and use this power to charge battery 95 (hence the name, motor generator). ECU 150 may control the inverter, adjust driving current supplied to MG 192, and adjust the current received from MG91 during regenerative coasting and braking.

Battery 195 may be implemented as one or more batteries or other power storage devices including, for example, lead-acid batteries, lithium ion, and nickel batteries, capacitive storage devices, and so on. Battery 195 may also be charged by one or more of MGs 191, 192, such as, for example, by regenerative braking or by coasting during which one or more of MGs 191, 192 operates as generator. Alternatively (or additionally, battery 195 can be charged by MG 191, for example, when HEV 100 is in idle (not moving/not in drive). Further still, battery 195 may be charged by a battery charger (not shown) that receives energy from engine 120. The battery charger may be switched or otherwise controlled to engage/disengage it with battery 195. For example, an alternator or generator may be coupled directly or indirectly to a drive shaft of engine 110 to generate an electrical current as a result of the operation of engine 110. Still other embodiments contemplate the use of one or more additional motor generators to power the rear wheels of a vehicle (e.g., in vehicles equipped with 4-Wheel Drive), or using two rear motor generators, each powering a rear wheel.

Battery 195 may also be used to power other electrical or electronic systems in the vehicle. Battery 195 can include, for example, one or more batteries, capacitive storage units, or other storage reservoirs suitable for storing electrical energy that can be used to power MG 191 and/or MG 192. When battery 195 is implemented using one or more batteries, the batteries can include, for example, nickel metal hydride batteries, lithium ion batteries, lead acid batteries, nickel cadmium batteries, lithium ion polymer batteries, and other types of batteries.

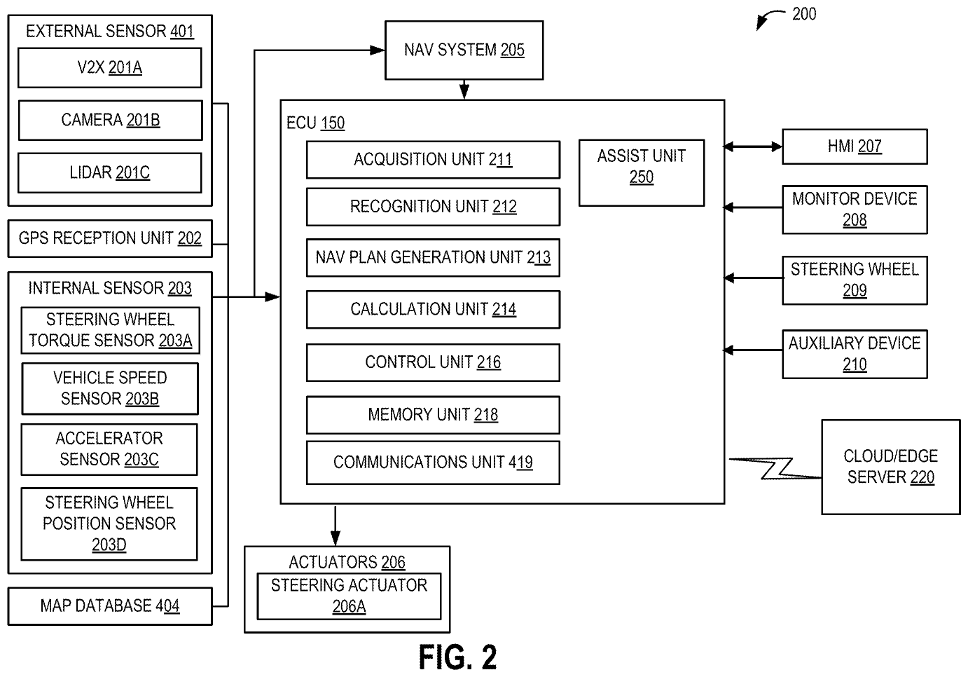

FIG. 2 illustrates an example autonomous control system 200 that may be used to autonomously and semi-autonomously control a vehicle, e.g., HEV 100. Autonomous control system 200 may be installed in HEV 100, and executes autonomous control of HEV 100. As described herein, autonomous control can refer to control that executes driving/assistive driving operations such as acceleration, deceleration, and/or steering of a vehicle, generally movement of the vehicle, without depending or relying on driving operations/directions by a driver or operator of the vehicle.

As an example, in one embodiment, autonomous control includes a steering wheel 209 that is steered automatically (without depending on a steering operation by the driver), even when the driver does not perform any steering operation. When an autonomous driving system controls the steering of the vehicle, the steering wheel is also actuated. In one embodiment, the autonomous and semi-autonomous driving systems produce decision elements (such as steering angle, or torque over time) which are implemented by lower-level controllers, resulting in movement of both the road wheels and the steering wheel.

For example, when the vehicle turns to the left or right, the steering wheel rotates appropriately. Typical autonomous vehicles operate in two modes: guardian, and chauffeur. A chauffeur mode is when the vehicle requires little or no input from the driver. A guardian mode is a mode in which the driver controls the vehicle, but the autonomous driving system can intervene when the vehicle is being piloted in an unsafe manner.

For example, autonomous control may include navigation control, where when there is no preceding vehicle in front of the HEV 100, constant speed (cruise) control is effectuated to make HEV 100 run at a predetermined constant speed. When there is a preceding vehicle in front of HEV 100, follow-up control is effectuated to adjust HEV 100's speed according to a distance between HEV 100 and the preceding vehicle.

In some scenarios, switching from autonomous control to manual driving may be executed. For example, when an operation amount of any of a steering operation, an acceleration operation, and brake operation by the driver of HEV 100 during the autonomous driving control becomes equal to or more than a threshold, autonomous control system 200 may execute a switch from autonomous control to manual control.

It should be understood that manual control or manual driving can refer to a vehicle operating status wherein a vehicle's operation is based mainly on driver-controlled operations/maneuvers. In an advanced driver assistance system (ADAS)/semi-autonomous vehicle (SAV) context, driving operation support control can be performed during manual driving. For example, a driver may be actively performing any of a steering operation, an acceleration operation, and a brake operation of the vehicle, while autonomous control system 200 performs some subset of one or more of those operations, e.g., in an assistive, complementary, or corrective manner. As another example, driving operation support control adds or subtracts an operation amount to or from the operation amount of the manual driving (steering, acceleration, or deceleration) that is performed by the driver.

In the example shown in FIG. 2, autonomous control system 200 is provided with an external sensor 201, a GPS (Global Positioning System) reception unit 202, an internal sensor 203, a map database 204, a navigation system 205, actuators 206, an HMI (Human Machine Interface) 207, a monitor device 208, a steering wheel 209, auxiliary devices 210, and an assist unit 250. Autonomous control system 200 may communicate with ECU 150, or in some embodiments (may be implemented with its own ECU).

In the example shown in FIG. 2, external sensor 201 is a detector that detects external circumstances such as surrounding information of HEV 100. The external sensor 201 may include a camera 210B, a Laser Imaging Detection and Ranging (LIDAR) unit 201C, and a vehicle-to-everything (V2X) receiver 201A. Other sensors may be included as an external sensor 201, e.g., a radar unit.

The camera 201B may be an imaging device that images the external circumstances surrounding the vehicle. For example, the camera is provided on a back side of a front windshield of the vehicle. The camera may be a monocular camera or a stereo camera. The camera 201B outputs, to the ECU 150, image information on the external circumstances surrounding the vehicle, image information/characteristics of a road/portion of roadway ahead of a vehicle or behind the vehicle (depending on camera 201B placement). The camera 201B is not limited to a visible light wavelength camera but can be an infrared camera.

The LIDAR unit 201C uses light waves to detect obstacles outside of the vehicle by transmitting light waves to the surroundings of the vehicle, and receiving reflected light waves from an obstacle to detect the obstacle, distance to the obstacle or a relative positional direction of the obstacle. The LIDAR unit outputs detected obstacle information to the ECU 150.

A V2X receiver 210A may be a radio or other electronic device including a transmitter or receiver operable to send/receive wireless messages using any V2X communications protocol. Examples of V2X protocols include, but are not limited to, e.g., dedicated short-range communication (DSRC), Long Term Evolution (LTE), millimeter wave communication, 5G-V2X, and so on. Almost any type or kind of information/data may be sent/received via V2X communications. For example, traffic information, road conditions information, weather information, neighboring vehicle information, etc. may be transmitted from a roadside unit to a vehicle, from one vehicle to another vehicle, and so on.

In one embodiment, a radar unit uses radio waves to detect obstacles outside of the vehicle by transmitting radio waves to the surroundings of the vehicle, and receiving reflected radio waves from an obstacle to detect the obstacle, distance to the obstacle or a relative positional direction of the obstacle. The radar unit outputs detected obstacle information to the ECU 50.

The LIDAR unit may operate similar to the manner in which the radar unit operates except that light is used in place of radio waves. The LIDAR unit outputs detected obstacle information to the ECU 50.

In the example shown in FIG. 2, GPS reception unit 202 receives signals from three or more GPS satellites to obtain position information indicating a position of HEV 100. For example, the position information can include latitude information and longitude information. The GPS reception unit 202 outputs the measured position information of the vehicle to the ECU 150.

In the example shown in FIG. 2, the internal sensor 203 can refer to a detector(s) for detecting information regarding, e.g., a running status of HEV 100, operational/operating conditions, e.g., amount of steering wheel actuation, rotation, angle, amount of acceleration, accelerator pedal depression, brake operation by the driver of HEV 100. The internal sensor 203 includes at least one of a vehicle speed sensor 203B, an accelerator (pedal) sensor 203C, a brake (pedal) sensor 203A, and other sensors, e.g., accelerometers such as a 3-axis accelerometer to detect roll, pitch, and yaw of HEV 100 (e.g., to detect vehicle heading), a steering sensor, an acceleration sensor (not shown, but well-understood in the art), etc.

Vehicle speed sensor 203B is a detector that detects a speed of the HEV 100. In some embodiments, HEV 100's speed may be measured directly or through calculations/inference depending on the operating conditions/status of one or more other components of HEV 100. For example, a wheel speed sensor can be used as the vehicle speed sensor 203B to detect a rotational speed of the wheel, which can be outputted to ECU 150.

The acceleration sensor can be a detector that detects actuation of an accelerator pedal (or other accelerator actuator) of HEV 100. For example, the acceleration sensor may include a longitudinal acceleration sensor for detecting a longitudinal acceleration of HEV 100, and a lateral acceleration sensor for detecting a lateral acceleration of HEV 100. The acceleration sensor outputs, to the ECU 150, acceleration information.

The yaw rate sensor can be a detector that detects a yaw rate (rotation angular velocity) around a vertical axis passing through the center of gravity of HEV 100. For example, a gyroscopic sensor is used as the yaw rate sensor. The yaw rate sensor outputs, to the ECU 150, yaw rate information including the yaw rate of HEV 100.

The steering sensor 203A may be a detector that detects an amount of a steering operation/actuation with respect to a steering wheel 30 by the driver of HEV 100. The steering operation amount detected by the steering sensor 203A may be a steering angle of the steering wheel or a steering torque applied to the steering wheel, for example. The steering sensor 203A outputs, to the ECU 150, information including the steering angle of the steering wheel 209 or the steering torque applied to the steering wheel 209 of HEV 100.

The accelerator sensor 203C may be a detector that detects a stroke amount of an accelerator pedal, for example, a pedal position of the accelerator pedal with respect to a reference position. The reference position may be a fixed position or a variable position depending on a determined parameter. The accelerator sensor 203C is provided on a shaft portion of the accelerator pedal of the vehicle, for example. The accelerator sensor 203C outputs, to the ECU 150, operation information reflecting the stroke amount of the accelerator pedal.

The brake sensor 203A may be a detector that detects a stroke amount of a brake pedal, for example, a pedal position of the brake pedal with respect to a reference position. Like the accelerator position, a brake pedal reference position may be a fixed position or a variable position depending on a determined parameter. The brake sensor 203A may detect an operation force of the brake pedal (e.g. force on the brake pedal, oil pressure of a master cylinder, and so on). The brake sensor 203A outputs, to the ECU 150, operation information reflecting the stroke amount or the operation force of the brake pedal.

A map database 204 may be a database including map information, such as, e.g., what is known in the art as a high definition or high density (HD) map. The map database 204 is implemented, for example, in a disk drive or other memory installed in HEV 100. The map information may include road position information, road shape information, intersection position information, and fork position information, for example. The road shape information may include information regarding a road type such as a curve and a straight line, and a curvature angle of the curve. When autonomous control system 200 uses a Simultaneous Localization and Mapping (SLAM) technology or position information of blocking structural objects such as buildings and walls, the map information may further include an output signal from external sensor 201. In some embodiments, map database 204 may be a remote data base or repository with which HEV 100 communicates.

Navigation system 205 may be a component or series of interoperating components that guides the driver of HEV 100 to a destination on a map designated by the driver of HEV 100. For example, navigation system 205 may calculate a route followed or to be followed by HEV 100, based on the position information of HEV 100 measured by GPS reception unit 202 and map information of map database 204. The route may indicate a running lane of a section(s) of roadway in which HEV 100 traverses, for example. Navigation system 205 calculates a target route from the current position of HEV 100 to the destination, and notifies the driver of the target route through a display, e.g., a display of a head unit, HMI 207 (described below), and/or via audio through a speaker(s) for example. The navigation system 205 outputs, to the ECU 150, information of the target route for HEV 100. In some embodiments, navigation system 205 may use information stored in a remote database, like map database 204, and/or some information processing center with which HEV 100 can communicate. A part of the processing executed by the navigation system 205 may be executed remotely as well.

Actuators 206 may be devices that execute running controls of HEV 100. The actuators 206 may include, for example, a throttle actuator, a brake actuator, and a steering actuator, such as steering actuator 206A. For example, the throttle actuator controls, in accordance with a control signal output from the ECU 150, an amount by which to open the throttle of HEV 100 to control a driving force (the engine) of HEV 100. In another example, actuators 206 may include one or more of MGs 191 and 192, where a control signal is supplied from the ECU 150 to MGs 191 and/or 192 to output motive force/energy. The brake actuator controls, in accordance with a control signal output from the ECU 150, the amount of braking force to be applied to each wheel of the vehicle, for example, by a hydraulic brake system. The steering actuator 206A controls, in accordance with a control signal output from the ECU 150, driving an assist motor of an electric power steering system that controls steering torque.

HMI 207 may be an interface used for communicating information between a passenger(s) (including the operator) of HEV 100 and autonomous control system 200. For example, the HMI 207 may include a display panel for displaying image information for the passenger(s), a speaker for outputting audio information, and operation buttons or a touch panel used by the occupant for performing an input operation. HMI 207 may also or alternatively transmit the information to the passenger(s) through a mobile information terminal connected wirelessly and receive the input operation by the passenger(s) through the mobile information terminal. In some embodiments, HMI 207 may output some form of haptic feedback in the form of vibrations or other sensory indicia, e.g., to alert a driver that HEV 100 is about to veer outside a current lane of travel.

Monitor device 208 monitors a status of the driver/operator. The monitor device 208 can check a manual driving preparation state of the driver. More specifically, the monitor device 208 can check, for example, whether or not the driver is ready to start manual operation of HEV 100. Moreover, the monitor device 208 can check, for example, whether or not the driver has some intention of switching HEV 100 to a manual mode of operation. As will be described in greater detail below, monitor device 208 may provide information or data, e.g., statistical data, characterizing preferred operating characteristics of a driver across a variety of timelines, e.g., while traversing a particular route, while operating HEV 100 during a particular period of time, season/weather condition (more aggressive operation during dry conditions as compared to more cautious operation during rainy conditions), etc.

For example, the monitor device 208 may be a camera that can take an image of the driver, where the image can be used for estimating the degree to which the driver's eyes are open, the direction of the driver's gaze, whether or not the driver is holding the steering wheel, etc. Monitor device 208 may also be a pressure sensor for detecting the amount of pressure the driver's hand(s) are applying to the steering wheel. As another example, the monitor device 208 can be a camera that takes an image of a hand of the driver. It should be understood that other sensors, e.g., accelerator sensor 203C, may be leveraged to obtain information characterizing the driving habits or preferences of a driver. Although accelerator sensor 203C does not sense any characteristic of the driver him/herself, the resulting operation of HEV 100, such as how often or how aggressive acceleration is performed can be indicative of a driver's behavior or driving preferences.

A steering wheel 209 can be a traditional steering wheel or other direction control device that may be actuated to pilot the vehicle in a particular lateral direction, whether the vehicle is progressing in a forward or rearward direction. In autonomous (AV) and semi-autonomous (SAV) vehicles, or vehicles capable of selective autonomous operation, steering wheel 209 may be present, but actuation of steering wheel 209 may be controlled by the vehicle's AV system. In some embodiments, AVs/SAVs are implemented in a manner by which the driver cannot impart control over the vehicle via the steering wheel, but in cases where overriding and/or ignoring driver steering input is not absolute, the system can use driver inputs (such as torque applied by the driver on the steering wheel) to adjust the rate of rotation of the steering wheel during a driving maneuver.

Auxiliary devices 210 may include devices that can be operated by the driver of the vehicle, but are not necessarily drive-related, such as actuators 206. For example, auxiliary devices 210 may include a direction indicator, a headlight, a windshield wiper and the like.

The ECU 150 may execute autonomous control of the vehicle. In one embodiment, the ECU includes an acquisition unit 211, a recognition unit 212, a navigation plan generation unit 213, a calculation unit 214, a presentation unit 215, and a control unit 216.

Acquisition unit 211 may obtain the following operation amounts or levels of actuation based on the information obtained by the internal sensor 203: steering operation, acceleration operation, and brake operation by the driver during an autonomous control mode; and the level of steering operation, acceleration operation, and brake operation by the driver of the vehicle during a manual control mode.

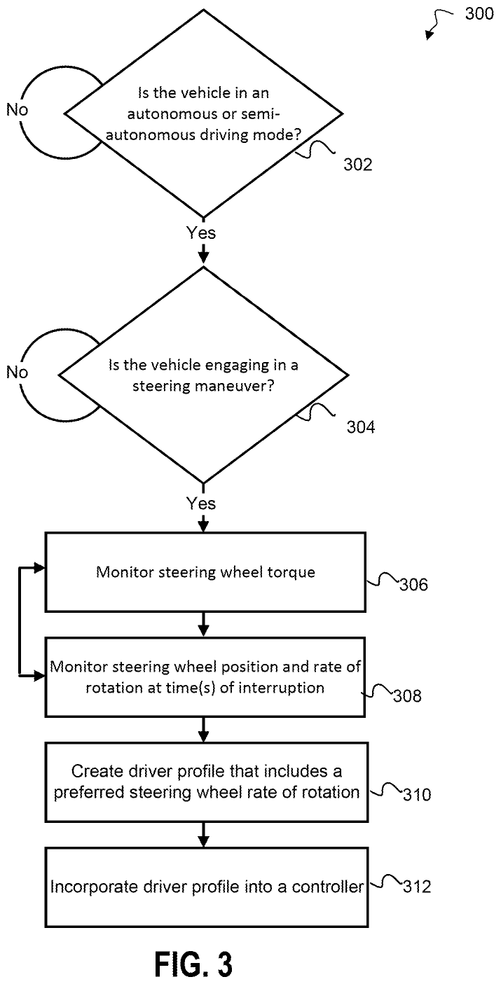

In some embodiments, based on the position of HVE 100 and the map information, acquisition unit 211 acquires the positional or other relevant information about lanes in the road-extending direction (for example, the direction indicated by arrow X in FIG. 3) on the road on which HEV 100 is traveling, and lane information in the road-width direction (for example, the direction indicated by an arrow Y in FIG. 3). Acquisition unit 211 may acquire positional information about the number of lanes comprising a road being traversed by HEV 100, lane characteristics (lane width, particular lane traversal instructions, e.g., a turn-only lane, etc.). Acquisition unit 211 may acquire lane information such as relative lane position, e.g., as it affects driver behavior. That is, in some areas/jurisdictions, applicable rules of the road dictate that slower traffic move to/remain in a rightmost lane of a roadway, while faster traffic move to/remain in a leftmost lane of a roadway. Acquisition unit 211 can acquire the position of HEV 100 based on the positioning result provided from the GPS reception unit 202. Acquisition unit 211 acquires map information from map database 204 (or from navigation system 205). Acquisition unit 211 acquires the positional information and lane information about the lane increase-decrease area present on the road ahead of HEV 100 in its traveling direction. Acquisition unit 211 may acquire the positional information and lane information within a predetermined distance from the current position of HEV 100 in its traveling direction.

Recognition unit 212 may recognize or assess the environment surrounding or neighboring vehicle(s) based on the information obtained by the external sensor 201, the GPS reception unit 202, and/or the map database 204. For example, the recognition unit 212 includes an object or obstacle recognition unit (not shown), a road width recognition unit (not shown), and a facility recognition unit (not shown). The obstacle recognition unit recognizes, based on the information obtained by the external sensor 201, obstacles surrounding the vehicle. For example, the obstacles recognized by the obstacle recognition unit include moving objects such as pedestrians, other vehicles, motorcycles, and bicycles and stationary objects such as a road lane boundary (white line, yellow line), a curb, a guard rail, poles, a median strip, buildings and trees. The obstacle recognition unit obtains information regarding a distance between the obstacle and the vehicle, a position of the obstacle, a direction, a relative velocity, a relative acceleration of the obstacle with respect to the vehicle, and a category and attribution of the obstacle. The category of the obstacle includes a pedestrian, another vehicle, a moving object, and a stationary object. The attribution of the obstacle can refer to a property of the obstacle such as hardness and a shape of the obstacle. Such information can impact vehicle or driving dynamics, which can impact the manner in which stowed cargo “reacts” (moves/shifts).

The road width recognition unit recognizes, based on the information obtained by the external sensor 201, the GPS reception unit 202, and/or the map database 204, a road width of a road in which the vehicle is running.

The facility recognition unit recognizes, based on the map information obtained from the map database 204 and/or the vehicle position information obtained by the GPS reception unit 202, whether or not vehicle 10 is operating/being driven through an intersection, in a parking structure, etc. The facility recognition unit may recognize, based on the map information and the vehicle position information, whether or not the vehicle is running in a school zone, near a childcare facility, near a school, or near a park, etc.

Navigation plan generation unit 213 may generate a navigation plan for HEV 100 based on the target route calculated by the navigation system 205, the information on obstacles surrounding HEV 100 recognized by recognition unit 212, and/or the map information obtained from map database 204. The navigation plan may be reflect one or more operating conditions/controls to effectuate the target route. For example, the navigation plan can include a target speed, a target acceleration, a target deceleration, a target direction, and/or a target steering angle with which HEV 100 should be operated at any point(s) along the target route so that the target route can be achieved to reach a desired destination. It should be understood that navigation plan generation unit 213 generates the navigation plan such that HEV 100 operates along the target route while satisfying one or more criteria and/or constraints, including, for example, safety constraints, legal compliance rules, operating (fuel/energy) efficiency, and the like. Moreover, based on the existence of obstacles surrounding HEV 100, the navigation plan generation unit 213 generates the navigation plan for the vehicle so as to avoid contact with such obstacles.

Presentation unit 215 displays, on a display of the HMI 207, a threshold which is calculated by the calculation unit 214 and used for determining whether or not to execute the switching from autonomous control to the manual driving or vice versa.

Control unit 216 can autonomously control HEV 100 based on the navigation plan generated by navigation plan generation unit 213. The control unit 216 outputs, to the actuators 206, control signals according to the navigation plan. That is, the control unit 216 controls actuators 206 based on the navigation plan, and thereby autonomous control of HEV 100 is executed/achieved. Control unit 216 may autonomously or semi-autonomously control HEV 100 based on other information, e.g., sensor information from external sensor 201 or internal sensor 203, or depending on lane characteristics (gleaned from lane recognition unit 212A), or monitor device 208 (such as driver preferences), or other information from recognition unit 212 (such as obstacle information, neighboring vehicle information, road characteristics information, etc.).

In some embodiments, data collection can comprise monitoring the operation of autonomous control system or aspects thereof, e.g., control unit 216 over time. Thus, the aforementioned data/information that is stored/logged can include time-series data involving some subset of or all aspects of autonomous control system 200. For example, commands from control unit 216 to actuators 206 may be monitored, and time-series data representative of the operating states/conditions of control unit 216 may be captured.

In one embodiment, the assist unit 250 provides autonomous or semi-autonomous driving assistance for driving of HEV 100 such that HEV 100 travels along or within a current or appropriate lane of travel. Traveling along or within a current or appropriate lane of travel includes autonomous or semi-autonomous driving maneuvers necessary to steer the vehicle within an appropriate lane of travel, or through intersections, winding roads, and portions of unmarked roadways. Specifically, assist unit 250 starts autonomous or semi-autonomous assistance in response to, for example, activation of an autonomous or semi-autonomous driving system by the driver. Assist unit 250 recognizes relevant lane indicators or boundaries, e.g., the white line(s) of the lane in which the HEV 100 is traveling, through image analysis based on, for example, an image of a road ahead of HEV 100 captured by camera 201B. The assist unit 250 recognizes the position of HEV 100 in the current lane of travel based on, for example, the positions of the white lines perceived in the captured image. In some embodiments, the assist unit 250 recognizes relevant physical markers or boundaries, e.g., an intersection, through which the HEV 100 will travel.

Next, assist unit 250 controls traveling of the HEV 100 by applying steering torque to steering wheel 209 of HEV 100 (by way of a signal(s) or instruction(s) transmitted by assist unit 250 to control unit 216, which may then send a corresponding control signal(s) or instruction(s) to actuators 206, in particular, steering actuator 206A) such that the recognized lateral position of HEV 100 is adjusted to a target lateral position, which in various embodiments, comprises a lane bias or offset distance relative to a center (or central range) of the current lane of travel.

Determination unit 214 may calculate a threshold used for determining whether or not to switch from autonomous control to manual driving or vice versa. The determination can be performed based on the operating levels associated with the manner in which the driver is operating HEV 100 during autonomous control which is obtained by the acquisition unit 211. For example, the driver of HEV 100 may suddenly grasp the steering wheel (which can be sensed by internal sensor 203) and stomp on the brake pedal (which can be sensed by monitor device 208). The pressure on the steering wheel and the level of actuation of the brake pedal may be excessive enough (exceed a threshold) suggesting that the driver intends to override the autonomous control system 200.

In some embodiments, determination unit 214 may reference a driver profile of the driver operating HEV 100. For example, based on instructions or signals from determination unit 214 that are transmitted to assist unit 250, assist unit 250 may generate corresponding signals or instructions for applying an appropriate amount of steering torque in an appropriate direction based on the driver profile determined by determination unit 214, and based on a current position of HEV 100 in the current lane of travel. For example, internal sensor 203, which as described above, includes at least one of a vehicle speed sensor 203B, an accelerator (pedal) sensor 203C, a brake (pedal) sensor 203A, and other sensors, e.g., accelerometers such as a 3-axis accelerometer to detect roll, pitch, and yaw of HEV 100 (e.g., to detect vehicle heading). Thus, the aforementioned instructions or signals transmitted to assist unit 250 instruct assist unit 250 to apply the appropriate amount of steering torque in the appropriate direction to guide HEV 100. Accordingly, assist unit 250 may transmit instructions or signals to control unit 216 to effectuate the appropriate amount of steering torque in the appropriate direction. In turn, control unit 216 may send corresponding instructions or signals to actuators 206, in particular, steering actuation 206A.

It should also be noted that while autonomous control system 200 is described herein in the context of various elements or components performing certain operations, the functionality of autonomous control system 200 and that of its elements/components can be implemented in a variety of ways. For example, more or less elements/components may be used to perform the functions/operations described herein. For example, the functionality of recognition unit 212 and assist unit 250 may be combined in some embodiments.

Additionally, recognition unit 211 may determine the width of road 300, e.g., the Y dimension, as well as the dimension(s), e.g., width, of lanes 302 and 304. Such information may be transmitted to assist unit 250, which may then calculate central areas/regions of lanes 302 and 304. For example, assist unit 250 may perform one or more calculations upon receiving roadway and lane widths from recognition unit 212/lane recognition unit 212A. For example, assist unit 250, may calculate the central portion of lanes 302 and 304 by dividing each width value by two. In other embodiments, the center of lanes 302 and 304 (302A and 304A, respectively) may be known vis-à-vis an HD map from map database 204. Those of ordinary skill in the art would know how to determine a central area/region of a lane(s). As described above, assist unit 250 and control unit 216 may operate to effectuate positioning HEV 100 accordingly.

FIG. 3 is a flow diagram of a method of altering an autonomous or semi-autonomous steering wheel rate of rotation, according to one embodiment. The method 300 includes monitoring the steering wheel torque, monitoring the steering position and rate at time(s) of interruption, creating a driver profile that includes a preferred steering rate, and incorporating the driver profile into a controller.

In one embodiment, torque applied to the steering wheel by the driver during an autonomous driving maneuver is measured by the steering wheel torque sensor 203A. The steering wheel torque data is sent is sent to the ECU 150, where it is stored in the memory unit 218. In addition, steering wheel rate of rotation data and steering wheel position data is gathered by the steering wheel position sensor 203D, and sent to the ECU 150, where it is stored in the memory unit 218. The calculation unit 214 fetches (i.e., gets) the steering wheel torque sensor data and steering wheel position sensor data from the memory unit 218 and determines a preferred steering rate of rotation of the steering wheel for future autonomous and semi-autonomous driving maneuvers. The preferred steering rate of rotation for the steering wheel, is then sent to the control unit 216 to alter the rate at which the autonomous and semi-autonomous driving modes engage in an steering maneuver. In one embodiment, the rate at which the autonomous or semi-autonomous driving engages in a steering maneuver is slowed down. Furthermore, once the calculation unit 214 determines a preferred steering rate of rotation for the steering wheel, the steering wheel rate of rotation is stored in memory 218. In one embodiment, the new rate of rotation is associated with a driver to create a driver profile.

In one embodiment, the preferred steering wheel rate is determined by comparing a first set of steering wheel position and rate of rotation data, captured before a torque is applied to the steering wheel, with a second set of steering wheel position and rate of rotation data, captured after a torque is applied to the steering wheel. The first set of position and rotation data is compared to the second set of position and rotation data to determine the amount of steering wheel rotation that a driver prefers. For example, if the rate of rotation of the steering wheel in the second set is slower than the rate of rotation of the steering wheel in the first set, then a driver preference for a decreased rate of rotation of the steering wheel is stored in memory as a preferred steering rate.

At activity 302, the method 300 includes determining whether the vehicle is in an autonomous or semi-autonomous driving mode. In one embodiment, the ECU 150 determines whether the vehicle is engaged in an autonomous or semi-autonomous driving mode. For example, the control unit 216 communicates with the assist unit 250 to determine whether the vehicle is engaged in an autonomous or semiautonomous driving mode. If the vehicle is not in an autonomous driving mode, activity 302 repeats. In one embodiment, the autonomous driving mode includes a chauffeur mode, and the semi-autonomous driving mode includes a guardian driving mode. If the ECU determines that the vehicle is in an autonomous or semi-autonomous driving mode then the method 300 includes progressing to activity 304.

At activity 304, the method 300 includes determining whether the vehicle is engaging in a driving maneuver. In one embodiment, the ECU 150 determines whether the vehicle is engaged in an autonomous or semi-autonomous driving mode. For example, the control unit 216 communicates with the nav plan generation unit 213 and the recognition unit 212 to determine whether the vehicle is engaging in a driving maneuver that requires the vehicle to rotate the steering wheel.

Examples of a driving maneuver include an autonomous lane change, right turn, left turn, acceleration, deceleration. The driving maneuvers further includes semi-autonomous driving maneuvers that include lane keep assist (LKA), and adaptive cruise control. If the ECU 150 determines that the vehicle is not engaging in a steering motion, the method 300 includes repeating activity 304. If the steering wheel monitoring system determines that the vehicle is engaging in a steering motion, the method 300 includes advancing to activity 306.

At activity 306, the method 300 includes monitoring the steering wheel torque for driver inputs. A driver input includes the driver physically touching the steering wheel to alter the rotation of the steering wheel. In one embodiment, steering wheel torque sensor 203A measures the amount of torque applied to the steering wheel by the driver. The amount of torque applied to the steering wheel by the driver is captured as steering wheel torque data. The steering wheel torque data is sent to the ECU 150, where it is used to determine a preferred steering wheel rate of rotation. Thus, in this embodiment, the ECU 150 monitors the steering wheel torque to measure the torque inputs provided by the driver to the steering wheel and adjust the rotation of the steering wheel. As explained in further detail at Activity 310, the captured steering wheel torque data is used by the ECU to determine the preferred steering wheel rate of the driver. The preferred steering wheel rate of the driver is used to create a driver profile. As explained further below, in one embodiment, the driver profile is stored in memory, while the preferred steering rate is sent to and executed by the control unit 216.

At activity 308, the method 300 includes monitoring the steering wheel position and the steering wheel rate of rotation to determine the position of the steering wheel and rate of rotation when the driver applied the torque to the steering wheel. In one embodiment, monitoring the steering wheel position includes capturing steering wheel position data using one or more wheel position sensor(s) 203D. The captured steering wheel position data is sent to the ECU 150. For example, the captured steering wheel position data is sent to the calculation unit 214. In one embodiment, the captured steering wheel position data is sent to memory unit 418 before it is sent to the calculation unit 214. In one embodiment, the steering wheel position data includes the amount of rotation (e.g., degrees of rotation) of the steering wheel from center. As explained in further detail below, the captured steering wheel position data is used by the ECU 150 to determine the preferred steering wheel rate of rotation. The preferred steering wheel rate of rotation is stored in memory unit 218 and associated with each driver to create a driver profile that includes the preferred steering wheel rate of rotation.

In one embodiment, steering wheel torque, position, and rate of rotation data is gathered/captured simultaneously. For example, in one embodiment, the steering wheel torque sensor 203A captures steering wheel torque data simultaneously with the steering wheel position sensor 203D gathering steering position data and or rate of rotation data. Both the steering wheel torque data and the steering wheel position data is sent to the assist unit 250 within the ECU 150. Thus, the assist unit 250 can monitor the steering wheel torque and steering wheel position simultaneously to determine the amount of torque that is applied to alter (e.g., speed up or slow down) the rate of rotation of the steering wheel, and the position of the steering wheel at the time when the driver physically interrupted the autonomous or semi-autonomous driving system by attempting to adjust the steering wheel rotation.

In one embodiment, both the steering wheel torque and the movement is measured by the steering wheel rate adjustment system simultaneously. For example, when a vehicle is operating in an autonomous mode (e.g., chauffeur mode) or in a semi-autonomous mode (e.g., guardian mode), the steering wheel rate adjustment system monitors the torque applied to the steering wheel at a first position of the steering wheel. By recording the approximate location at which the torque was applied to the steering wheel, the steering wheel rate adjustment system determines the point at which the driver intervened with the steering wheel in chauffeur or guardian mode.

The explained in further detail below, the driver interaction with the autonomous and semi-autonomous mode can is tracked and stored to a create a driver profile database. The driver profile is then used to adjust the rate at which the steering wheel rotates to adjust to the driver's preferences of steering wheel rotation and prevent driver interruption to the autonomous and semi-autonomous driving modes.

At activity 310, the method 300 includes generating a driver profile that includes a preferred steering wheel rate of rotation. In one embodiment, the preferred steering wheel rate of rotation is determined by the ECU 150. Here, steering wheel torque, position, and rate of rotation data is captured by one or more sensors 203 and sent to the ECU 150, to determine a preferred steering wheel rate of rotation. As previously mentioned, the one or more sensors 203 include the steering wheel torque sensor 203A and steering wheel position sensor 203D. In one embodiment, the captured steering wheel torque, position, and rate of rotation data is stored in memory unit 218. The data is fetched (i.e., received) by the calculation unit 214 to determine the preferred steering wheel rate of rotation.

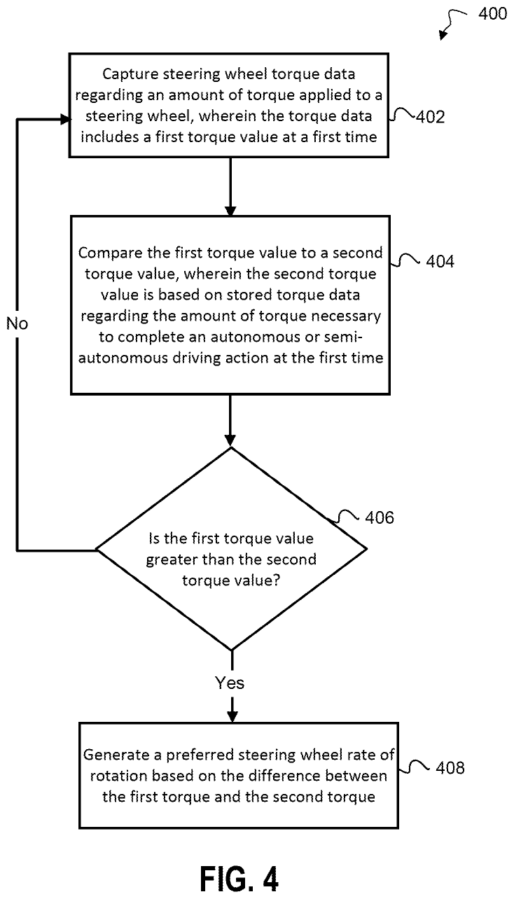

In one embodiment, the preferred steering wheel rate of rotation is determined by using a first set of steering wheel position and rate of rotation data before a torque is applied to the steering wheel, and capturing a second set of steering wheel position and rate of rotation data after a torque is applied to the steering wheel. The first set of steering wheel position and rate of rotation data is compared to the second set of steering wheel position and rate of rotation data to determine a preferred rate of rotation. As explained in further detail in FIG. 4, the preferred rate of rotation includes altering the previous rate of steering wheel rotation to correspond to the rate of rotation which the driver desires. The rate of rotation which the driver desires corresponds to the rate of rotation which the driver attempted to rotate the steering wheel.

In one embodiment, the preferred steering rate is determined by calculating a moving average of the measured steering rate over a fixed window. Because the inertia and friction characteristics of the steering column/wheel can be estimates a priori, the system can estimate how much torque is needed to move the steering wheel with a given acceleration and rate, and can therefore determine that the driver is intervening (e.g., modifying the steering rate) by measuring torque in excess of its prediction.

Furthermore, the steering wheel torque data and the steering wheel position data is used by the ECU 150 to develop a driver profile. Here, the preferred rate of rotation for the steering wheel is stored in memory 218 and associated with the driver to create a driver profile. In one embodiment, each driver who drives the vehicle during an autonomous or semi-autonomous driving mode can have their own driver profile, so that each driver's preferred rate of steering wheel rotation can be associated with each driver. For example, a first driver may prefer that the autonomous or semi-autonomous steering slow down during a turning maneuver, while a second driver may prefer that the autonomous or semi-autonomous steering speed up during a turning maneuver.

Furthermore, in one embodiment, data associated with each driver's profile (e.g., each driver's preferred rate of steering wheel rotation), is sent to a server where it stored along with other driver's profiles. The plurality of driver profile data is then used to determine an average rate of steering wheel rotation. The average rate of steering wheel rotation is then used to adjust the rate of steering wheel rotation during autonomous or semi-autonomous driving modes.

Here, the autonomous and semi-autonomous driving modes can determine how the driver interacts with the steering wheel. For example, if the driver provides torque to the steering wheel to slow down the steering wheel rate, this information can be stored to develop a driver profile. In another example, if the driver provided torque to the steering wheel to speed up the steering wheel rate, this information can be stored to develop a driver profile. Over time, the drive profile can be generated for the driver regarding the numerous situations of how quickly/slowly the driver prefers the steering wheel to be actuated by the autonomous driving system.

Thus, using the driver profile, the autonomous driving system can adjust how quickly or slowly it moves the steering wheel to match the driver's preference. For example, the steering wheel rate adjustment system can use captured data regarding a first driver's previous steering interactions with the autonomous system and semiautonomous driving system to adjust the rate of steering to decrease the driver's need to interrupt the autonomous or semi-autonomous driving mode. Interrupting the autonomous and semi-autonomous driving mode includes speeding up/or slowing down the rotation of the steering wheel.

FIG. 4 is a flow diagram of a method 400 for determining the preferred steering rate according to one embodiment. In one embodiment, the method 400 includes: capturing torque data regarding the amount of torque applied to a steering wheel, wherein the torque data includes a first torque value at a first time; comparing the first torque value to a second torque value, wherein the second torque value is gathered from stored torque data regarding the amount of torque necessary to complete an autonomous or semi-autonomous driving action at the first time; and generating a preferred steering wheel rate of rotation based on the difference between the first torque value and the second torque value if the first torque value is greater than the second torque value.

At activity 402, the method 400 includes capturing a first set of torque data regarding the amount of torque applied to the steering wheel, wherein the first set of torque data includes a first torque value at a first time. Here, the steering wheel torque sensor 203A measures steering wheel torque to determine whether or not a torque is applied to the steering wheel. When a torque is applied to the steering wheel by the driver, the amount of torque is measured by the torque sensor 203A. The amount of torque that was applied (i.e., “the interruption”) and the data regarding the length of time of the interruption is sent to and stored in the memory unit 218 as a first torque value at a first time.

In one embodiment, the steering wheel torque sensor 203A measures the steering wheel torque to determine a first torque value at a first time. The steering wheel torque data comprising a first torque value at a first time is sent to and stored in the memory unit 218 as a first torque value at the first time. As explained in further detail below, the first torque value at the first time is compared to a second torque value at the first time by the ECU 150 to determine a preferred rate of steering wheel rotation.

In another embodiment, a first set of torque data includes a first set of torque values, captured during a first portion of time. Here, the first set of torque values are captured by the steering wheel torque sensor 203A, throughout a portion of time, and sent to the memory unit 218. For example, a set of torque values captured throughout an autonomous or semi-autonomous steering maneuver (e.g., 4-10 seconds). As explained further at activity 408, the first set of torque values at the first portion of time are compared to a second set of torque values at the first portion of time by the ECU 150 to determine a preferred rate of steering wheel rotation.

At activity 404, the method 400 includes comparing the first torque value with a second torque value, wherein the second torque value is based on stored torque data regarding the amount of torque necessary to complete an autonomous or semi-autonomous driving action at the first time. In one embodiment, the ECU 150 references steering wheel torque data stored in the memory unit 218 regarding the amount of torque necessary to rotate the steering wheel during an autonomous or semi-autonomous driving maneuver. The stored steering wheel torque data includes a second torque value. Here, the ECU 150 gathers torque value data from the memory unit 218 to compare the first torque value captured by the steering wheel torque sensor 203A at the first time with the second torque value regarding the amount of torque necessary to complete an autonomous driving maneuver at the first time.

In one embodiment, activity 404 includes comparing the first set of toque values captured during a first portion of time with a second set of torque values regarding the amount of torque necessary to complete the autonomous driving maneuver at the first portion of time. Here, the ECU 150 gathers torque value data from the memory unit 218 to compare the first set of torque values captured by the steering wheel torque sensor 203A at the first time with the second torque values regarding the amount of torque necessary to complete an autonomous driving maneuver at the first time.

At activity 406, the method 400 includes determining whether the first torque value at the first time is greater than the second torque value at the first time. Here, the ECU 150 receives (e.g., fetches) data, from the memory unit 218, that includes the first torque value at the first time and the second torque value at the first time, and compares the first torque value to the second torque to determine whether the first torque value is greater than the second torque value. If the first torque value is greater than the second torque value, the method 400 includes progressing to activity 408. If the first torque value is less than or equal to the value of the second torque value, the method 400 includes repeating activity 402 to capture torque data regarding the amount of applied to the steering wheel.

In one embodiment, the method includes determine whether a first set of torque values at the first portion of time are greater than the second set of torque values at the first portion of time. Here, the ECU 150 receives (e.g., fetches) data from the memory unit 218, that includes the first set of torque values at the first portion of time and the second set of torque values at the first portion of time, and compares the first set of torque values to the second set of torque values to determine whether the first set of torque values are greater than the second set of torque values. If the first set of torque values are greater than the second set of torque values, the method 400 includes progressing to activity 408. If the first set of torque values are less than or equal to the second set of torque values, the method includes repeating activity 402.

At activity 408 the method 400 includes generating a preferred steering wheel rate of rotation based on the difference between the first torque and the second torque. In one embodiment, the first torque value at the first time is compared to the second torque value at the first time by the ECU 150 to determine a preferred rate of steering wheel rotation. Here, the preferred rate is the difference between the first torque value (e.g., captured torque) and the second torque value (e.g., torque applied to the steering wheel by the autonomous or semi-autonomous driving system to conduct a maneuver). In another embodiment, the first set of torque values at the first portion of time are compared to the second set of torque values at the first portion of time by the ECU 150 to determine a preferred rate of steering wheel rotation. For example, in one embodiment, the ECU 150 uses its knowledge of how much torque is needed to produce the rotation of the steering wheel during an autonomous and semi-autonomous steering maneuver and compares it to the torque value(s) captured by the steering wheel torque sensor 203A. If the captured steering wheel torque values are sufficiently different than the reference steering wheel torque values, then the ECU 150 determines that the driver is applying a torque. After a fixed-window of time has passed, the ECU 150 determines a moving average of the measured steering wheel rate of rotation, and determines the preferred steering wheel rate of rotation based on the moving average. The ECU 150 continues determining a moving average of the measured steering wheel rate of rotation as long as the steering wheel torque sensor 203A is capturing a torque (e.g., an interruption applied by the driver).

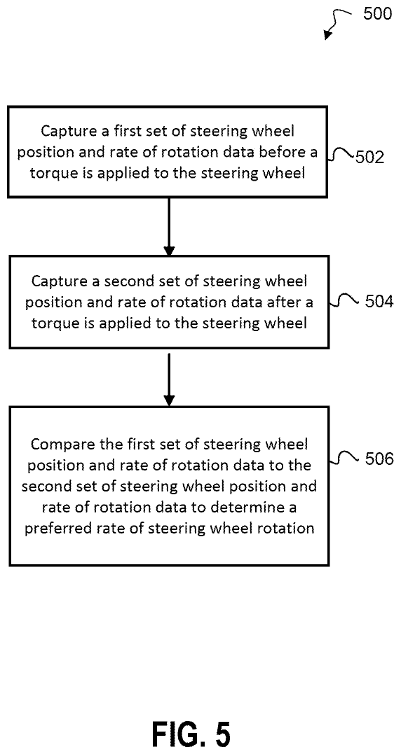

FIG. 5 is a flow diagram of an alternative method 500 for determining the preferred steering rate according to one embodiment. The method 500 includes capturing a first set of steering wheel position and rate of rotation data before a torque is applied to the steering wheel, capturing a second set of steering wheel position and rate of rotation data after a torque is applied to the steering wheel, and comparing the first set of steering wheel data to the second set of steering wheel data to determine a preferred rate of rotation.

At activity 502, the method 500 includes capturing a first set of steering wheel position and rate of rotation data before a torque is applied to the steering wheel. In one embodiment, the steering wheel torque sensor 203A measures the steering wheel torque to determine whether or not a torque is applied to the steering wheel. Here, the steering wheel position sensor 203D measures the steering wheel position and rate of rotation to capture data regarding the rate of rotation of the steering wheel during an un-interrupted autonomous or semi-autonomous driving mode. The steering wheel position data and steering wheel rate of rotation data is sent to and stored in the memory unit 218 as a first set of steering wheel rate of rotation and position data. As explained in further detail below, the first set of steering wheel rate of rotation and position data is compared to a second set of steering wheel rate of rotation and position data by the ECU 150 to determine a preferred rate of steering wheel rotation.

At activity 504, the method 500 includes capturing a second set of steering wheel position and rate of rotation data after a torque is applied to the steering wheel. Here, the steering wheel torque sensor 203A measures the steering wheel torque to determine whether or not a torque is applied to the steering wheel. When a torque is applied to the steering wheel by the driver, the steering wheel position sensor 203D measures the steering wheel position and rate of rotation to capture data regarding the rate of rotation of the steering wheel during the interrupted autonomous or semi-autonomous driving mode. Here, the steering wheel position data and steering wheel rate of rotation data at the time the torque was applied (i.e., “the interruption”) is sent to and stored in the memory unit 218 as a second set of steering wheel rate of rotation and position data. The second set of steering wheel rate of rotation and position data is compared to the first set of steering wheel rate of rotation and position data by the ECU 150 to determine a preferred rate of steering wheel rotation.

At activity 506, the method 500 includes comparing the first set of steering wheel data to the second set of steering wheel data to determine a preferred rate of rotation. In one embodiment, the first set and second set of steering wheel rate of rotation and position data is fetched (i.e., received) by the ECU 150. The ECU 150 compares the first set of steering wheel rate of rotation and position data to the first set of steering wheel rate of rotation and position data to determine a preferred rate of steering wheel rotation

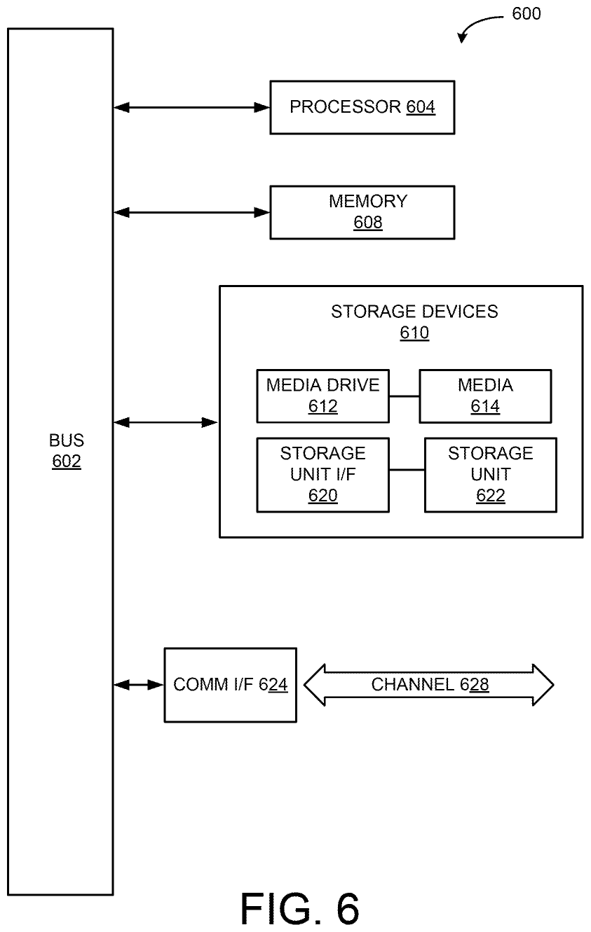

FIG. 6 is an example computing component that may be used to implement various features of embodiments described in the present disclosure. Computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up a user device, a user system, and a non-decrypting cloud service. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 512 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 500.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of adjusting a rate of rotation of a steering wheel in an autonomous vehicle comprising:
measuring a torque applied to the steering wheel at a first time by a driver during an autonomous driving mode;
determining a preferred rate of rotation based on the measured torque applied to the steering wheel at the first time; and
adjusting the rate of rotation during an autonomous driving mode, to comport with the preferred rate of rotation.

2. The method of claim 1, wherein determining a preferred steering wheel rate comprises:
capturing a first set of steering wheel torque data regarding an amount of torque applied to a steering wheel, wherein the first set of steering wheel torque data includes a first set of torque values at the first time;
comparing the first set of torque values at the first time with a second set of torque values at the first time, wherein the second set of torque values are based on stored torque data regarding the amount of steering wheel torque necessary to complete an autonomous driving maneuver; and
generating a preferred steering wheel rate of rotation based on the difference between the first set of torque values and the second set of torque values.

3. The method of claim 2, further comprising:
generating a driver profile, for one or more drivers of the vehicle, that includes the preferred steering wheel rate of rotation for each of the one or more drivers.

4. The method of claim 1, wherein adjusting the steering wheel rate of rotation during an autonomous driving mode to include the preferred steering wheel rate of rotation includes slowing down the rate of rotation of the steering wheel.

5. The method of claim 1, wherein the autonomous driving mode includes a semi-autonomous driving mode.

6. The method of claim 5, wherein the autonomous driving mode includes a chauffeur mode.

7. The method of claim 5, wherein the semi-autonomous driving mode includes a guardian mode.

8. A method of adjusting a rate of rotation of a steering wheel in an autonomous vehicle comprising:
measuring a torque applied to the steering wheel by a driver during an autonomous driving mode, wherein the torque is applied to the steering wheel by the driver to interrupt an autonomous driving maneuver;
measuring the steering wheel position at a time of interruption;
measuring the steering wheel rate of rotation at the time of interruption;
determining a preferred rate of rotation based on the measured torque at the time of interruption; and
adjusting the rate of rotation, during an autonomous driving mode, to include the preferred steering wheel rate of rotation.

9. The method of claim 8, wherein determining a preferred steering wheel rate comprises:
capturing a first set of steering wheel position data before a torque is applied to the steering wheel;
capturing a first set of steering wheel rate of rotation data before a torque is applied to the steering wheel;
capturing a second set of steering wheel position data after a torque is applied to the steering wheel;
capturing a second set of steering wheel rate of rotation data after a torque is applied to the steering wheel;
comparing the first set of steering wheel position and rate of rotation data to the second set of steering wheel position and rate of rotation data to determine whether the rate of rotation of the steering wheel should be decreased.

10. The method of claim 8, further comprising:
generating a driver profile, for one or more drivers of the vehicle, that includes the preferred steering wheel rate of rotation for each of the one or more drivers.

11. The method of claim 8, wherein adjusting the steering wheel rate of rotation during an autonomous driving mode to include the preferred steering wheel rate of rotation includes slowing down the rate of rotation of the steering wheel.

12. The method of claim 8, wherein the autonomous driving mode includes a semi-autonomous driving mode.

13. The method of claim 12, wherein the autonomous driving mode includes a chauffeur mode.

14. The method of claim 12, wherein the semi-autonomous driving mode includes a guardian mode.

15. A system for altering the rate of steering wheel rotation during an autonomous driving mode comprising:
a processor;
a memory having computer readable instructions stored thereon, which when executed by the processor, cause the processor to:
measure a torque applied to the steering wheel by a driver during an autonomous driving maneuver;
measure the steering wheel position;
measure the rate of rotation, wherein the steering wheel position and rate of rotation are measured at the time when the torque was applied to the steering wheel;
determine a preferred steering wheel rate; and
adjust the steering wheel rate during an autonomous driving maneuver to include the preferred steering wheel rate.

16. The system of claim 15, wherein the memory unit includes instructions that when executed further cause the processor to:
capture a first set of steering wheel position data before a torque is applied to the steering wheel;
capture a first set of steering wheel rate of rotation data before a torque is applied to the steering wheel;
capture a second set of steering wheel position data after a torque is applied to the steering wheel;
capture a second set of steering wheel rate of rotation data after a torque is applied to the steering wheel; and
compare the first set of steering wheel position and rate of rotation data to the second set of steering wheel position and rate of rotation data to determine the preferred steering wheel rate of rotation.

17. The system of claim 15, wherein the memory unit includes instructions that when executed further cause the processor to:
generate a driver profile, for each driver of the vehicle, that includes the preferred steering wheel rate of rotation for each driver.

18. The system of claim 16, wherein comparing the first set of steering wheel position and rate of rotation data to a second set of steering wheel position and rate of rotation data to determine the preferred steering wheel rate of rotation further includes determining whether the rate of rotation of the steering wheel should be decreased.

19. The method of claim 15, wherein adjusting the steering wheel rate of rotation during an autonomous driving mode to include the preferred steering wheel rate of rotation includes slowing down the rate of rotation of the steering wheel.

20. The method of claim 15, wherein the autonomous driving mode includes a semi-autonomous driving mode.
